(19) United States
(12) Patent Application Publication
(10) Pub. No.: US 2019/0030736 A1
(43) Pub. Date: Jan. 31, 2019

(54) LOCKING STRUCTURE AND FOLDABLE CUTTER AND FOLDABLE PAPER CUTTER APPLYING THE STRUCTURE

(71) Applicant: Feng Chen, Yangjiang City (CN)

(72) Inventor: Feng Chen, Yangjiang City (CN)

(21) Appl. No.: 15/804,366

(22) Filed: Nov. 6, 2017

(30) Foreign Application Priority Data
Jul. 31, 2017 (CN) 201720942245.5

(51) Int. Cl. B26B 5/00

(52) U.S. Cl. CPC B26B 5/005; B26B 1/042

(57) ABSTRACT

Disclosed is a foldable cutter with a locking structure, including a cutter head having a blade and a connecting portion. The locking structure is rotatablely connected with the connecting portion. The locking structure includes a rotation shaft; at least two elastic check pawls arranged in the connecting portion; at least one gasket arranged on the connection portion, and provided with a second shaft hole matching with the rotation shaft, and a crescent gear groove extending around the second shaft hole; and at least one bidirectional unlocking rotor disc arranged on the gasket or on the connection portion, and provided with a third shaft hole matching with the rotation shaft, and a profiled hole.

### CROSS-REFERENCE TO RELATED APPLICATION

This application is based on and claims the benefit of priority from Chinese Patent Application No. 201720942245.5, filed on Jul. 31, 2017, the contents of which are incorporated by reference.

### FIELD

The invention relates to a technical field of cutter, in particular to a locking structure and a foldable cutter with the locking structure, and more particularly to a foldable paper cutter with the locking structure.

### BACKGROUND

Most of the foldable cutters on the market only have two folding angles, i.e., a completely unfolded angle and a completely folded angle. Such a foldable cuter, while used as a cutter, may be generally acceptable in functions, but while used as a tool, may not be satisfactory as functional limitations occur. A paper cutter with a ratchet structure according to the existing art has a complex operation, and its locking structure is not firm and reliable enough.

### SUMMARY

To overcome the above-mentioned defects of the existing art, the invention is to provide a foldable cutter with a locking structure. Such a foldable cutter, due to its well-designed simple structure, and consequently obtained capability of providing arbitrary opening and closing angles, can be widely applied into various occasions and has the advantages of easy opening and closing and convenient blade replacement.

In order to achieve the above-mentioned beneficial effects, a technical solution is employed in the invention, and described as follows.

According to several aspects, a foldable cutter with a locking structure is disclosed. The foldable cutter includes a cutter head having a blade and a connecting portion having a first shaft hole. A locking structure is rotatablely connected with the connecting portion. The locking structure includes a rotation shaft, matching with the first shaft hole; at least two elastic check pawls, arranged in the connecting portion; and at least one gasket, arranged on the connection portion, and provided with a second shaft hole matching with the rotation shaft, and a crescent gear groove extending around the second shaft hole. The at least two elastic check pawls are configured to elastically engage with the crescent gear groove to allow the gasket to rotate in directions opposite to each other. At least one bidirectional unlocking rotor disc, arranged on the gasket or on the connection portion, and provided with a third shaft hole matching with the rotation shaft, and a profiled hole configured in such a way that, when the connection portion is forced to rotate in a direction with respect to the bidirectional unlocking rotor disc, one of the at least two elastic check pawls, which prevents the rotation of the connection portion with respect to the gasket in the direction, is pressed by a side wall the profiled hole to disengage from the crescent gear groove.

In an additional aspect of the present disclosure, the locking structure includes two gaskets arranged on either side of the connection portion. The locking structure further includes two bidirectional unlocking rotor discs arranged on outer sides of the gaskets.

Each of the at least two elastic check pawls includes a jacking piece engaged with the crescent gear groove, and the cutter head is provided with two profiled holes on the connection portion. The jacking piece is fixed with one end thereof in a corner of the profiled hole such that the other end thereof is pivotable in the profiled hole, and the jacking piece extends laterally into profiled hole of the bidirectional unlocking rotor disc through the crescent gear groove of the gasket.

Each of the at least two elastic check pawls further includes a spring, arranged in the profiled hole between the other end of jacking piece and one side of the profiled hole.

The foldable cutter further includes two rotor disc housings, symmetrically arranged on outer sides of the two bidirectional unlocking rotor discs; and two outer lateral plates, symmetrically arranged on outer sides of the two gaskets.

The rotation shaft has an end portion configured to not allow a rotatable connection with the bidirectional unlocking rotor disc.

The crescent gear groove includes a plurality of teeth configured to engage with each of the at least two elastic check pawls.

The cutter head further includes a blade lock, a U-shaped spring, a base plate, a cover plate, a front spacer and a rear spacer. The blade is an isosceles trapezoid with a narrow upper portion and a wide lower portion, and provided with two grooves at a top thereof, into which the blade lock are locked.

The U-shaped spring is received in an arc groove of the rear spacer, a top of a right side of the U-shaped spring is in contact with a neck at a tail end of the blade lock, a left side thereof is bent to left by 90 degrees and extends to form a U shape, and a bottom thereof abuts against the blade, the front spacer is placed on the top of the blade.

The blade lock is provided with a toggle on the top thereof, and a hook bent downward and clipped into one of the grooves on the top of the blade.

As compared to the cutters of the prior art, the locking structure and foldable cutter and foldable paper cutter with the locking structure according to the present invention has the benefit effects as provided below: the cutter is simple in structure, convenient to use and suitable for various occasions, its opening and closing angles can be adjusted and locked arbitrarily according to specific needs; the cutter has firm and reliable locking performance. In addition, its blade replacement is more convenient.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an exploded view of a foldable cutter according to an exemplary embodiment;

FIG. 2 is a schematic view of a bidirectional unlocking rotor disc according to an exemplary embodiment;

FIG. 3 is a schematic view of a replaceable cutter head according to an exemplary embodiment;

FIG. 4 is a schematic view of a foldable cutter with a replaceable blade according to an exemplary embodiment; and

FIG. 5 is a schematic view of a foldable cutter with an irreplaceable blade according to an exemplary embodiment.

### DETAILED DESCRIPTION

The following description is merely exemplary in nature and is not intended to limit the present disclosure, application, or uses.

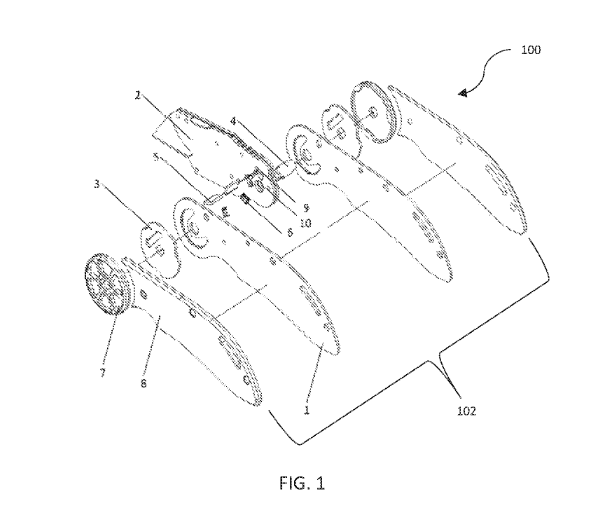

As shown in FIG. 1, in an embodiment of the invention, a folding cutter 100 with a locking structure, generally indicated by reference number 102, according to the invention comprises a cutter head 2 and the locking structure 102. The locking structure 102 comprises two outer side plates 8, two bidirectional unlocking rotor discs 3, two gaskets 1, two unlocking rotor disc housings 7 and a rotation shaft 4. The unlocking rotor disc housings 7, the bidirectional unlocking rotor discs 3, the gaskets 1 and the cutter head 2 are respectively provided with a shaft hole matching with the rotation shaft 4, the former three are successively and symmetrically arranged on either side of the cutter head 2 via the rotation shaft 4 and the shaft holes.

Specifically, the two gaskets 1 are symmetrically arranged on and pivotally connected with the cutter head 2 through a first shaft hole 10 formed in the connection portion, second shaft holes formed in the gaskets 1 and the rotation shaft 4, and the two outer lateral plates 8 are symmetrically mounted on outer sides of the gaskets 1. The gaskets 1 and the outer lateral plates 8 form a handle of the foldable cutter. A space is formed between the gaskets 1 to receive the cutter head 2 in a folded state.

In a similar way, the two bidirectional unlocking rotor discs 3 are symmetrically arranged on the outer sides of the gaskets 1 through third shaft holes formed therein and the rotation shaft 4, and the unlocking rotor disc housings 7 are symmetrically mounted on the outer sides of the bidirectional unlocking rotor discs 3.

The locking structure 102 further comprises two elastic check pawls 5 which are arranged in the connecting portion. Correspondingly, each of the gasket 1 is provided with a crescent gear groove extending around one of the second shaft holes and comprising a plurality of teeth.

In an embodiment of the invention, each of the two elastic check pawls comprises a jacking piece 5, which is configured to engage with the crescent gear groove. The cutter head 2 is provided with two profiled holes 9 on the connection portion, wherein the jacking piece 5 is fixed with one end thereof in a corner of the profiled hole 9 such that the other end thereof is pivotable in the profiled hole 9. Each of the two elastic check pawls further comprises a spring 6, which is arranged in a profiled hole 9 between the other end of jacking piece 5 and one side of the profiled hole 9.

The two jacking pieces 5 laterally extends into the crescent gear grooves and elastically engage with the teeth of the crescent gear grooves under the action of the springs 6, and more importantly, the two elastic check pawls 5 are configured to allow the gaskets 1 to rotate in directions opposite to each other, while engaged with the crescent gear grooves simultaneously. That means, while the two elastic check pawls 5 are engaged with the crescent gear grooves, the rotation of the cutter head 2 with respect to the gaskets 1 are prevented, and thus the cutter head 1 is locked at a specific angle.

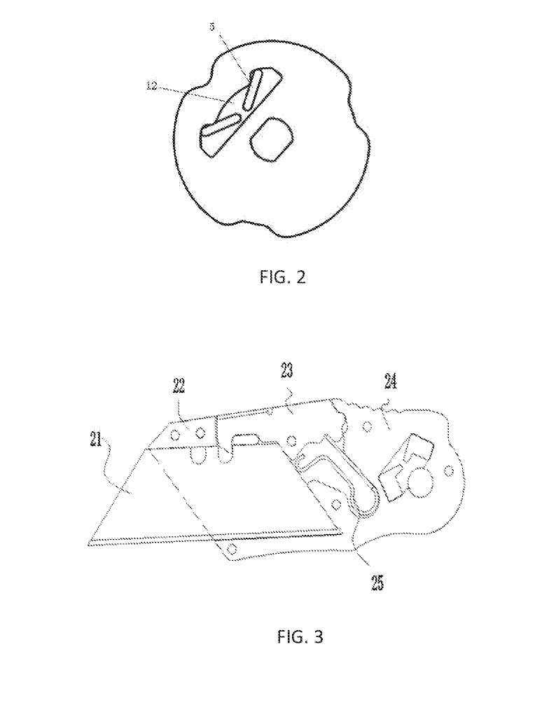

Further, in order to unlock the cutter head 2, the two bidirectional unlocking rotor discs 3 are required. As shown in FIG. 2, each of the rotor discs 3 is provided with an elongated profiled hole 12,and the jacking pieces 5 extends laterally into the elongated profiled holes 12 of the rotor discs 3 through the crescent gear grooves. The elongated profiled hole 12 an profile hole 9 has two inwards protruding bulges formed at an upper side thereof, and is configured in such a way that, when the connection portion is forced to rotate in a direction with respect to the bidirectional unlocking rotor disc 3, one of the two elastic check pawls 5, which prevents the rotation of the connection portion with respect to the gaskets 1 in the direction, is pressed by one of the bulges of the elongated profiled hole 12 to disengage from the crescent gear groove.

As shown in FIG. 1 again, the rotation shaft 4 has an end portion configured to not allow a rotatable connection with the bidirectional unlocking rotor disc 3. In addition, the unlocking rotor disc housings 7 are fixedly connected with the rotation shaft 4.

The locking structure can be applied to all folding tools and cutters.

When a user want to adjust the opening angle of the foldable cutter of the invention, the user may by one hand holds the handle of the cutter and by fingers presses the unlocking rotor disc housings 7 to prevent them from rotation simultaneously, and by the other hand rotate the cutter head 2 outwardly to open or inwardly to close. As the unlocking rotor disc housings 7 are fixedly connected with the rotation shaft 4, and the rotation shaft 4 has an end portion configured to not allow a rotatable connection with the bidirectional unlocking rotor discs 3, while the unlocking rotor disc housings 7 are stationary, the bidirectional unlocking rotor discs 3 are also stationary. Resulting from above, while the cutter head 2 is forced to rotate by user, one of the two elastic check pawls 5 is disengaged from the crescent gear grooves by the elongated profiled holes 12, the cutter head 2 is thus allowed to rotate step by step by means of the crescent gear grooves and another one of the two elastic check pawls 5, for a step-by-step adjustment. While the cutter head 2 is adjusted to an opening angle expected, the use may loosen its fingers to allow the bidirectional unlocking rotor discs 3 to rotate freely, for example, with the rotation shaft 4. In this state, both the two elastic check pawls 5 are engaged with the crescent gear grooves, the cutter header 2 is locked at the current position.

As shown in FIG. 3, the cutter head 2 further comprises a blade 21, a blade lock 23, a base plate (not shown), a cover plate (not shown), a front spacer 22 and a rear spacer 24, the blade 21 is an isosceles trapezoid with a narrow upper portion and a wide lower portion, and two grooves to receive the blade lock 23 are provided at the top of the blade 21.

The U-shaped spring 25 is received in an arc groove of the rear spacer 24, a top of a right side of the U-shaped spring 25 is in contact with a neck at a tail end of the blade lock 23, a left side thereof is bent to left by 90 degrees and extends to form a U shape, and a bottom thereof abuts against the blade 21, the front spacer 22 is placed on the top of the blade 21.

Preferably, the blade lock 23 is provided with a toggle on the top at the tail end thereof, and a hook bent downward at a front end thereof and clipped into one of the grooves on the top of the blade 21. The blade lock 23, both the front and tail ends of which can flexibly rotate up and down, is placed in the inner of the base plate and the cover plate through the shaft holes at the lower end.

While replacing the blade 21, the user may press down the toggle of the blade lock 23 to upraise the front end of the blade lock 23, so as to allow the hook of blade lock 23 to disengage from of the grooves in the blade 21. In the meanwhile, the tail end, which is pressed down by the user, forces the right side of the U-shaped spring in contact with the tail end, and consequently the U-shaped spring, to move forward, so that the blade is popped out of a slot in the cutter head 2. After that, a new blade 21 can be inserted in the slot, and locked by the blade lock 23.

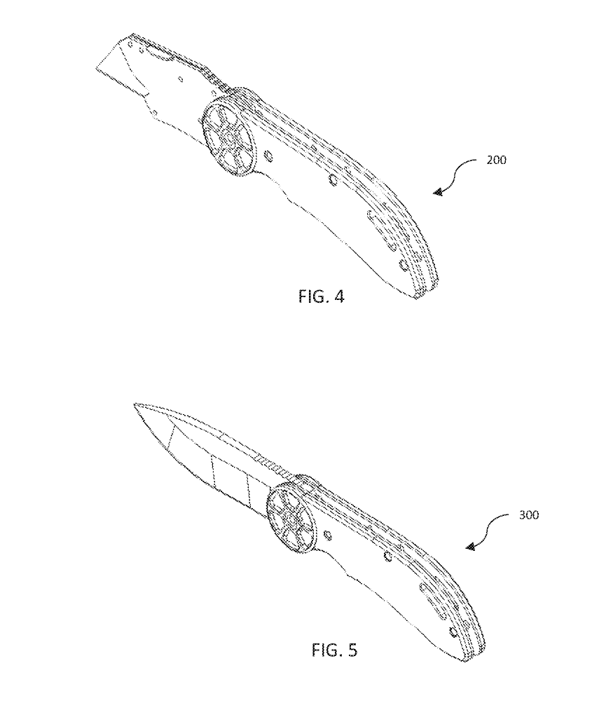

FIG. 4 shows a schematic view of a foldable cutter 200 according to the invention, wherein the cutter head 2 is changeable.

FIG. 5 shows a schematic view of a foldable cutter 300 according to the invention, wherein the cutter head 2 is unchangeable.

The above-described embodiments are preferred implementations of the invention, but the implementations of the invention are not limited thereto. Any other changes, modifications, substitutions, combinations and simplifications made within the spirit and principle of the invention should be regarded as equivalents of the invention, and are included within the protection scope of the invention.

What is claimed is:

1. A foldable cutter with a locking structure, comprising:
a cutter head, comprising:
a blade; and
a connecting portion, provided with a first shaft hole;
a locking structure, rotatablely connected with the connecting portion, and comprising:
a rotation shaft, matching with the first shaft hole;
at least two elastic check pawls, arranged in the connecting portion;
at least one gasket, arranged on the connection portion, and provided with a second shaft hole matching with the rotation shaft, and a crescent gear groove extending around the second shaft hole, wherein the at least two elastic check pawls are configured to elastically engage with the crescent gear groove to allow the gasket to rotate in directions opposite to each other;
at least one bidirectional unlocking rotor disc, arranged on the gasket or on the connection portion, and provided with a third shaft hole matching with the rotation shaft, and an elongated profiled hole configured in such a way that, when the connection portion is forced to rotate in a direction with respect to the bidirectional unlocking rotor disc, one of the at least two elastic check pawls, which prevents the rotation of the connection portion with respect to the gasket in the direction, is pressed by a side wall the elongated profiled hole to disengage from the crescent gear groove.

2. The foldable cutter according to claim 1, wherein the locking structure comprises two gaskets on either sides of the connection portion, and two bidirectional unlocking rotor discs on outer sides of the gaskets, wherein:
each of the at least two elastic check pawls comprises a jacking piece engaged with the crescent gear groove, and the cutter head is provided with two profiled holes on the connection portion, wherein the jacking piece is fixed with one end thereof in a corner of the profiled hole such that the other end thereof is pivotable in the profiled hole, and the jacking piece extends laterally into the elongated profiled hole of the bidirectional unlocking rotor disc through the crescent gear groove of the gasket.

3. The foldable cutter according to claim 2, wherein each of the at least two elastic check pawls further comprises a spring, arranged in the profiled hole between the other end of jacking piece and one side of the profiled hole.

4. The foldable cutter according to claim 2, further comprising:
two rotor disc housings, symmetrically arranged on outer sides of the two bidirectional unlocking rotor discs; and
two outer lateral plates, symmetrically arranged on outer sides of the two gaskets.

5. The foldable cutter according to claim 1, wherein the rotation shaft has an end portion configured to not allow a rotatable connection with the bidirectional unlocking rotor disc.

6. The foldable cutter according to claim 1, wherein the crescent gear groove comprises a plurality of teeth configured to engage with each of the at least two elastic check pawls.

7. The foldable cutter according to claim 1, wherein the cutter head further comprises a blade lock, a U-shaped spring, a base plate, a cover plate, a front spacer and a rear spacer, wherein the blade is an isosceles trapezoid with a narrow upper portion and a wide lower portion, and provided with two grooves at a top thereof, into which the blade lock are locked.

8. The foldable cutter according to claim 8, wherein the U-shaped spring is received in an arc groove of the rear spacer, a top of a right side of the U-shaped spring is in contact with a neck at a tail end of the blade lock, a left side thereof is bent to left by 90 degrees and extends to form a U shape, and a bottom thereof abuts against the blade, the front spacer is placed on the top of the blade.

9. The foldable cutter according to claim 8, wherein the blade lock is provided with a toggle on the top thereof, and a hook bent downward and clipped into one of the grooves on the top of the blade.
